(19) United States
(12) Patent Application Publication
(10) Pub. No.: US 2019/0143249 A1
(43) Pub. Date: May 16, 2019

(54) LIQUID FILTER

(71) Applicant: Yury BORISOV, Paris (FR)

(72) Inventor: Yury BORISOV, Paris (FR)

(21) Appl. No.: 16/152,565

(22) Filed: Oct. 5, 2018

(30) Foreign Application Priority Data
Nov. 16, 2017 (CA) 2 985 790

(51) Int. Cl. B01D 29/15; B01D 29/90; B01D 29/94; B01D 29/58

(52) U.S. Cl. CPC B01D 29/15; B01D 29/58; B01D 29/94; B01D 29/908

(57) ABSTRACT

A liquid filter has an outer housing and a filter drum. The outer housing has an outer wall and a pair of end walls that are positioned on opposed sides of the outer wall. The outer housing has an inlet and at least one outlet. The filter drum has a side wall, a first end wall and a second end wall. The first end wall and the second end wall are positioned on opposed sides of the side wall. The filter drum is secured within the outer housing. The filter drum has a t least one filter fastened in at least one of the first end wall and the second end wall to allow liquid to flow from an exterior of the filter drum to an interior of the filter drum. The inlet is positioned on the outer housing such that liquid is fed tangentially in relation to the filter drum through the inlet to create a centrifugal force within the outer housing causing solid particles to be forced towards the outer wall of the outer housing. The filter drum has at least one outlet pipe in fluid communication with the interior of the filter drum and the at least one outlet of the outer housing through which filtered liquid may pass.

### FIELD OF THE DISCLOSURE

The present application relates generally to a liquid filter, more specifically to a liquid filter for removing small suspended solids from suspension.

### BACKGROUND

This section provides background information to facilitate a better understanding of the various aspects of the invention. It should be understood that the statements in this section of this document are to be read in this light, and not as admissions of prior art.

Filter bags are commonly used for filtration purposes. It is often necessary when using filter bags to pre-filter liquid before filtration on thin membranes to avoid clogging of filter bags. Filter bags also require regular cleaning to maintain effectiveness. This means that there may be significant downtime for a filter system while regular cleaning maintenance is performed.

### BRIEF SUMMARY

There is provided a liquid filter with an outer housing and a filter drum. The outer housing has an outer wall and a pair of end walls positioned on opposed sides of the outer wall. The outer housing has an inlet and at least one outlet. The filter drum has a side wall, a first end wall and a second end wall. The first end wall and the second end wall are positioned on opposed sides of the side wall. The filter drum is secured within the outer housing. The filter drum has at least one filter fastened in at least one of the first end wall and the second end wall to allow liquid to flow from an exterior of the filter drum to an interior of the filter drum. The inlet of the outer housing is positioned such that liquid is fed tangentially in relation to the filter drum through the inlet to create centrifugal force within the outer housing that causes solid particles to be forced towards the outer wall of the outer housing. The filter drum has at least one outlet pipe in fluid communication with the interior of the filter drum and the at least one outlet of the outer housing through which filtered liquid may pass.

In one embodiment, the inlet is positioned on the outer wall equidistant from the pair of end walls of the outer housing.

In another embodiment, at least one filter is fastened in the first end wall and at least one filter is fastened in the second end wall.

In another embodiment, an inlet pipe is provided in fluid communication with the inlet of the outer housing. The size of the inlet pipe can be altered to change the force at which liquid enters the outer housing. A smaller diameter pipe may provide more force than a larger diameter pipe.

In another embodiment, a solids trap is provided at a bottom of the outer housing for collecting the solids not in fluid suspension. Solids that are forced towards the outer wall of the outer housing may slide down the walls to the solids trap. A drain may be provided in communication with the solids trap to allow for the removal of solids from the outer housing. In addition, a pump may be provided to discharge the collected solids from the solids trap.

In one embodiment, the filter is capable of capturing solid particles sized as small as 2 micrometers. Depending upon the type of filter used, the size of the solid particles collected may change. Filters that capture solid particles between 2 and 100 micrometers may be used.

In one embodiment, the outlet on the outer housing is positioned on one of the end walls. When an outlet is positioned on one of the end walls, it may be necessary to provide a pump to pump the filtered liquid out of the liquid filter.

In another embodiment, the outlet on the outer housing is positioned adjacent to the bottom of the outer housing. When an outlet is positioned adjacent to the bottom of the outer housing, it may be possible to utilize the force of gravity to assist with the removal of filtered fluid from the liquid filter. A pump may also be used for this purpose.

In one embodiment, a filter screen is positioned adjacent and exterior to the at least one filter. The filter screen filters out smaller particles than the at least one filter. The filter screen is placed exterior to the at least one filter such that any solid particle passing through the filter screen will pass through the at least one filter.

In one embodiment, an outlet pipe of the filter drum extends at least a portion of the way into the filter drum. The outlet pipe may have a single aperture or multiple apertures into which the filtered liquid may pass.

In one embodiment, at least a portion of the side wall of the filter drum is adjacent to the outer wall of the outer housing.

In one embodiment, the filter drum is centrally located within the outer housing.

There is also provided a liquid filter with an outer housing and a filter drum. The outer housing has an outer wall and a pair of end walls positioned on opposed sides of the outer wall. The outer housing has an inlet and at least one outlet. The filter drum has a side wall, a first end wall and a second end wall. The first end wall and the second end wall are positioned on opposed sides of the side wall. The filter drum is secured within the outer housing. The filter drum has at least one filter fastened in the side wall to allow liquid to flow from an exterior of the filter drum to an interior of the filter drum. The inlet of the outer housing is positioned such that liquid is fed tangentially in relation to the filter drum through the inlet to create centrifugal force within the outer housing that causes solid particles to be forced towards the outer wall of the outer housing. The filter drum has at least one outlet pipe in fluid communication with the interior of the filter drum and the at least one outlet of the outer housing through which filtered liquid may pass.

In one embodiment, the inlet is positioned on the outer wall equidistant from the pair of end walls of the outer housing.

In another embodiment, an inlet pipe is provided in fluid communication with the inlet of the outer housing. The size of the inlet pipe can be altered to change the force at which liquid enters the outer housing. A smaller diameter pipe may provide more force than a larger diameter pipe.

In another embodiment, a solids trap is provided at a bottom of the outer housing for collecting the solids not in fluid suspension. Solids that are forced towards the outer wall of the outer housing may slide down the walls to the solids trap. A drain may be provided in communication with the solids trap to allow for the removal of solids from the outer housing. In addition, a pump may be provided to discharge the collected solids from the solids trap.

In one embodiment, the filter is capable of capturing solid particles sized as small as 2 micrometers. Depending upon the type of filter used, the size of the solid particles collected may change. Filters that capture solid particles between 2 and 100 micrometers may be used.

In one embodiment, the outlet on the outer housing is positioned on one of the end walls. When an outlet is positioned on one of the end walls, it may be necessary to provide a pump to pump the filtered liquid out of the liquid filter.

In another embodiment, the outlet on the outer housing is positioned adjacent to the bottom of the outer housing. When an outlet is positioned adjacent to the bottom of the outer housing, it may be possible to utilize the force of gravity to assist with the removal of filtered fluid from the liquid filter. A pump may also be used for this purpose.

In one embodiment, a filter screen is positioned adjacent and exterior to the at least one filter. The filter screen filters out smaller particles than the at least one filter. The filter screen is placed exterior to the at least one filter such that any solid particle passing through the filter screen will pass through the at least one filter.

In one embodiment, an outlet pipe of the filter drum extends at least a portion of the way into the filter drum. The outlet pipe may have a single aperture or multiple apertures into which the filtered liquid may pass.

In one embodiment, at least a portion of the side wall of the filter drum is adjacent to the outer wall of the outer housing.

In one embodiment, the filter drum is centrally located within the outer housing.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a top plan view of a liquid filter.

FIG. 2 is a front elevation view, partially in section, of the liquid filter shown in FIG. 1.

FIG. 3 is a front elevation view of the liquid filter shown in FIG. 1.

FIG. 4 is a side elevation view, partially in section, of the liquid filter shown in FIG. 1.

FIG. 5 is a side elevation view of the liquid filter shown in FIG. 1.

### DETAILED DESCRIPTION OF THE PREFERRED EMBODIMENTS

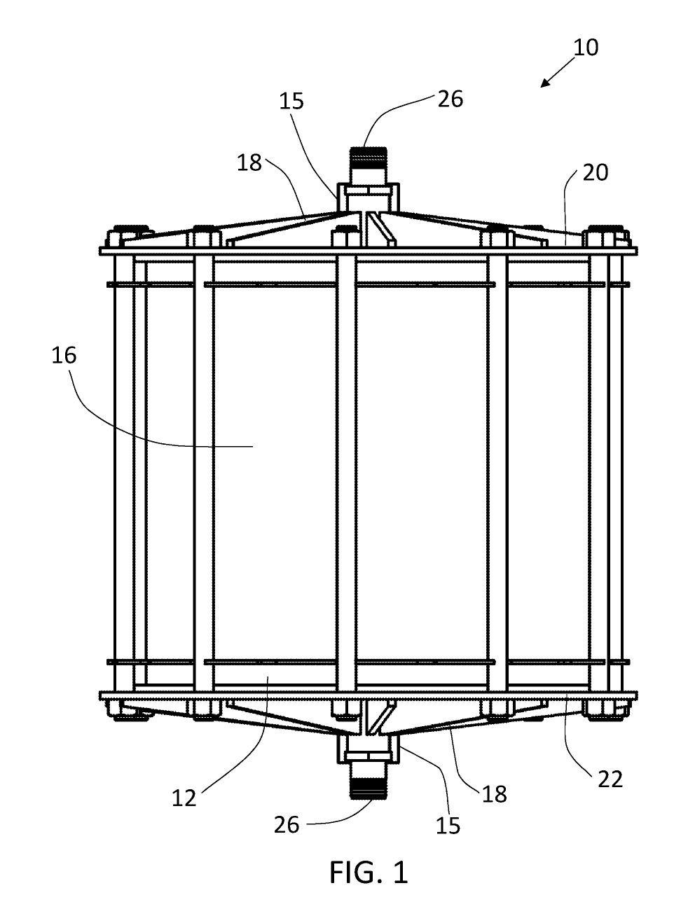

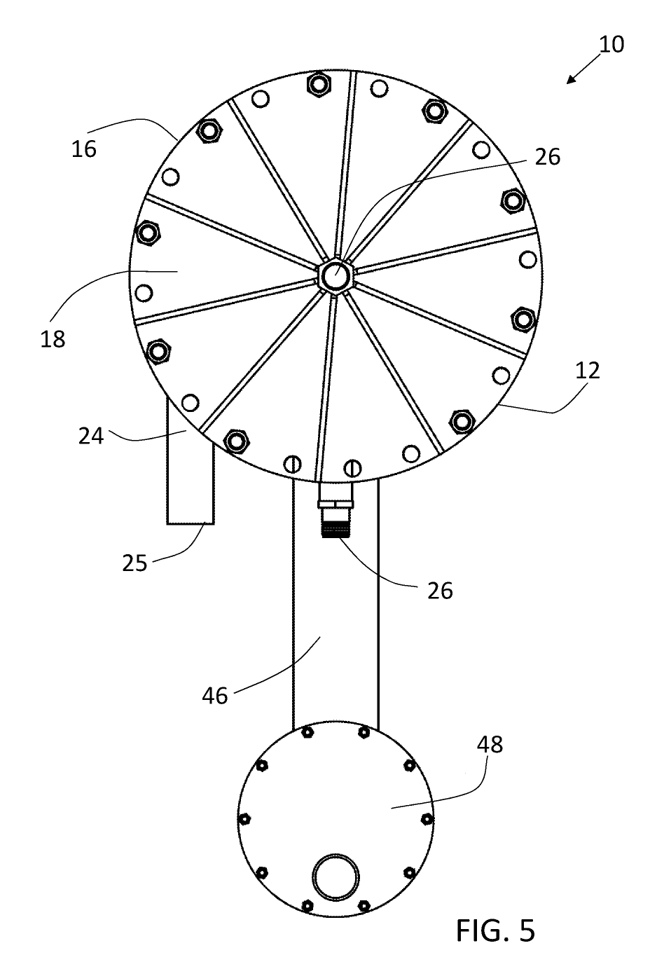

A liquid filter, generally identified by reference numeral 10, will now be described with reference to FIG. 1 through FIG. 5

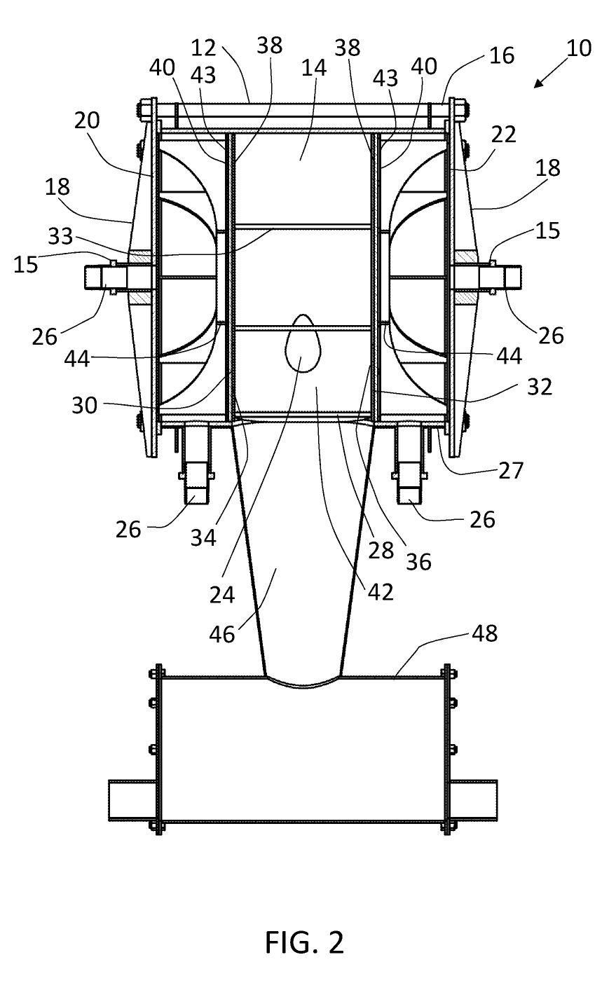

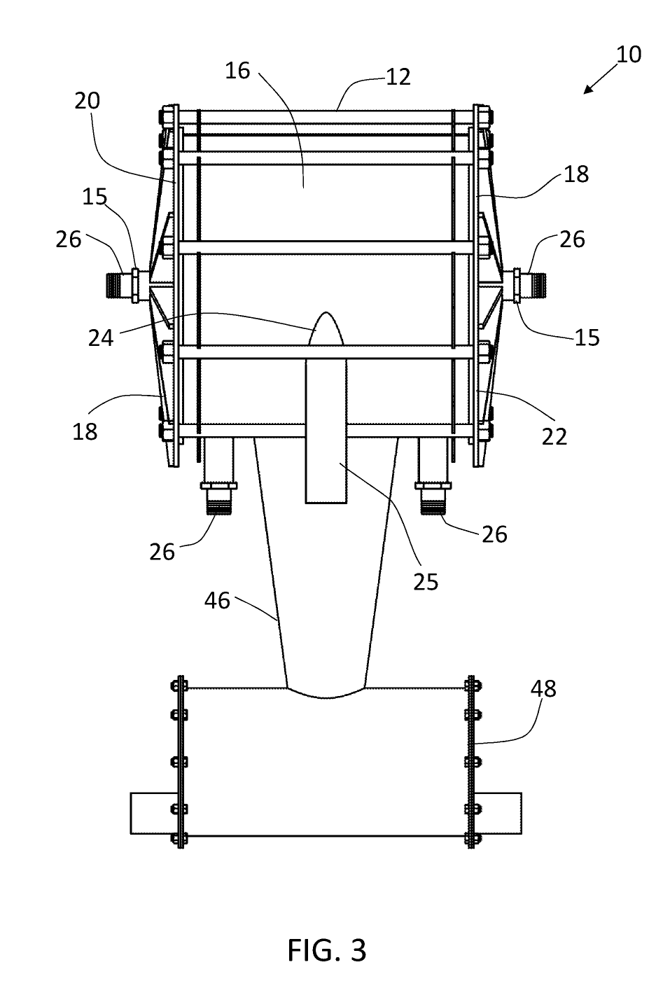

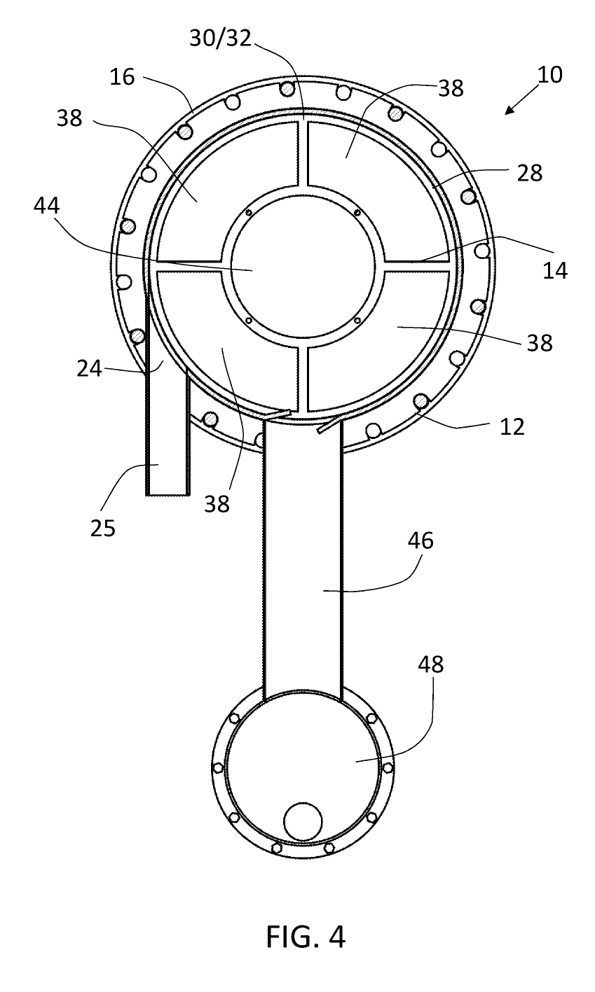

Referring to FIG. 2, a liquid filter 10 has an outer housing 12 with a filter drum 14 positioned within outer housing 12. Filter drum 14 is secured in position within outer housing 12 through the use of clamps 15 and sealant. It will be understood by a person skilled in the art that filter drum 14 may be permanently secured or removably secured within outer housing 12. Having a removably secured filter drum 14 allows for more simple maintenance or replacement of filter drum 14 in the event of damage to filter drum 14. Referring to FIG. 1, outer housing 12 has an outer wall 16 and a pair of end walls 18. End walls 18 are positioned on opposed sides 20 and 22 of outer wall 12. Referring to FIG. 3, Outer housing has an inlet 24 and at least one outlet 26. An inlet pipe 25 may be provided in fluid communication with inlet 24 to feed liquid from a liquid source, not shown, through inlet pipe 25 and inlet 24 into outer housing 12. Referring to FIG. 2, four outlets 26 are shown, one on each end wall 18 and two positioned adjacent a bottom 27 of outer wall 14. It will be understood that outlet 26 may be provided in any other location on outer housing 12. Any outlet 26 not being used may be sealed to prevent leakage from liquid filter 10. Filter drum 14 has a side wall 28, a first end wall 30 and a second end wall 32. First end wall 30 and second end wall 32 are positioned on opposed sides 34 and 36 of side wall 28. First end wall 30 and second end wall 32 are connected to opposed sides 34 and 36, respectively, of side wall 28 in such a manner that a fluid tight seal is created. This prevents fluid from entering an interior 42 of filter drum 14 unless it passes through a filter 38. Filter drum 14 is secured in a non-rotating fashion. In the embodiment shown, filter drum 14 is centrally located in relation to outer housing 12. It will, however, be understood that filter drum 14 may be positioned anywhere within outer housing 12. In the embodiment shown, filter drum 14 has at least one filter 38 fastened in at least one of first end wall 30 and second end wall 32 to allow liquid to flow from an exterior 40 of filter drum 14 to an interior 42 of filter drum 14. Referring to FIG. 4, in the embodiment shown, multiple filters 38 are fastened to first end wall 30 and second end wall 32 which allows for fluid to pass into filter drum 14 from either side. It will be understood that the size of particles captured by filters 38 is dependent upon the type of filter used. Filters 38 may be exchanged to allow for different size particles to be collected. In one embodiment, filters 38 are designed to capture particles as small as 2-100 micrometers.

Referring to FIG. 4, inlet 24 is positioned on outer housing 12 such that liquid is fed tangentially in relation to filter drum 14. Referring to FIG. 2, in the embodiment shown, inlet 24 is positioned on outer wall 16 equidistant from end walls 18 of outer housing 12. It will be understood that inlet 24 may be positioned anywhere on outer housing 12 as long as the feed of liquid entering outer housing occurs tangentially in relation to filter drum 14. The tangential flow of the liquid entering outer housing 12 creates a centrifugal force within outer housing 12 as the liquid is forced into a whirling pattern. This whirling pattern is created by the force of the liquid entering outer housing 12. The whirling pattern of the liquid will cease when liquid is no longer forced into outer housing 12 through inlet 24. Solid particles not in solution are forced toward outer wall 16 of outer housing 12. These solid particles include those solids filtered out of solution as liquid travels through filters 38. Referring to FIG. 2, in the embodiment shown, two outlet pipes 44 are provided in fluid communication with interior 42 of filter drum 14 and outlets 26 of outer housing 12 through which filtered liquid may pass. It will be understood that a single outlet pipe 44 or multiple outlet pipes 44 may be used depending upon the outlet 26 through which filtered fluid will pass. Outlet pipe 44 may extend part way into filter drum 14 for the collection of filtered fluids. A pump, not shown, may be used to assist in the discharge of the filtered liquid from outer housing 12 through outlet 44. Without a pump, fluid may be forced out of outlet pipe 44 due to the pressure of fluid entering through inlet 24.

In the embodiment shown in FIG. 2, a plurality of points 33 of side wall 28 may be positioned adjacent to outer wall 16 of outer housing 12 to create several non-fluid tight compartments that can hold unfiltered liquid. These compartments are created by spaces between points 33 of side wall 28, outer wall 16, first end wall 30 and second end wall 32. This is generally acceptable for filtering small volumes of liquid in pressurized systems. There is, however, a drawback in that the lack of free movement within outer housing 12 may cause the formation of different filtering parameters in each compartment.

It will be understood by a person skilled in the art that filters 38 may be fastened anywhere on filter drum 14, including on side wall 28, first end wall 30 or second end wall 32. However, side wall 28 of filter drum 14 generally provides mechanical strength functions to filter drum 14. When filters 38 are positioned on side wall 28, the strength of filter drum 14 can be affected which can result in failure of filter 10 during use.

Over time, it may become necessary to service or replace filter drum 14. It is possible to remove one or both of end walls 18 to facilitate this process and gain access to an interior of outer housing 12. Prior to servicing or replacing filter drum 14, the flow of liquid through liquid filter 10 should be stopped.

Referring to FIG. 2, when capturing small particles, it can be beneficial to provide a filter screen 43 sized to capture smaller particles than filters 38. Filter screen 43 is positioned adjacent and exterior to filters 38. Placing filter screens 43 exterior to filters 38 allows any solid particle passing through filter screen 43 to also pass through filter 38. Filter screen 43 is used to filter dirty liquid passing from exterior of filter drum to interior of filter drum. Filters 38 provide support to filter screen 43 and prevents deforming of filter screen 43 in the absence of or a drop is pressure. In the event of damage to filter screen 43, filters 38 may also provide filtration to liquids within filter 10.

A solids trap 46 is positioned at bottom 27 of outer housing 12. The solids that are forced outwards against outer wall 16 slide downwards due to gravity and collect in solids trap 46. A drain 48 is provided in communication with solids trap 46 for the removal of solids from outer housing 12. Drain 48 is positioned below solids trap 46 so that gravity can be utilized in moving solids into drain 48. A pump, not shown, may be provided to allow for assisted discharge of collected solids from solids trap 46 and drain 48. In one embodiment, the pump for discharging collected solids is run only when a predetermined quantity of solid material accumulates within drain 48. The pump discharges collected solids from drain 48 and can pull a small amount of liquid into drain 48 to rinse drain 48. The pump may also be set to operate continuously at a low flow rate.

When in use, liquid filter 10 must be primed such that filter drum 14 is engulfed by fluid. Liquid filter 10 is designed to allow for operation under pressure and may operate at a pressure of 6 atmospheres when necessary. Fluid is filtered through the process of cross-filtration wherein a dirty stream of liquid moves in a perpendicular plane to the filtering surface. Suction pressure may be created through the use of a pump to drive fluid through filters 38 from exterior 40 to interior 42 of filter drum 14. Utilizing a cross-filtration effect can also be beneficial in cleaning filters 38 during use of liquid filter 10. This self-cleaning mechanism may allow for less maintenance downtime for filter cleaning. It will be understood by a person skilled in the art that valves, pressure sensors, flow meters and other control devices may be placed within liquid filter 10, at inlet 24, outlets 26 and outlet pipe 44 to monitor and control flow through liquid filter.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. A liquid filter, comprising:
an outer housing having an outer wall and a pair of end walls positioned on opposed sides of the outer wall, the outer housing having an inlet and at least one outlet;
a filter drum having a side wall, a first end wall and a second end wall, the first end wall and the second end wall being positioned on opposed sides of the side wall, the filter drum being secured within the outer housing, the filter drum having at least one filter fastened in at least one of the first end wall and the second end wall to allow liquid to flow from an exterior of the filter drum to an interior of the filter drum, the inlet being positioned on the outer housing such that liquid is fed tangentially in relation to the filter drum through the inlet to create a centrifugal force within the outer housing causing solid particles to be forced towards the outer wall of the outer housing, the filter drum having at least one outlet pipe in fluid communication with the interior of the filter drum and the at least one outlet of the outer housing through which filtered liquid may pass.

2. The liquid filter of claim 1 wherein the inlet is positioned on the outer wall equidistant from the pair of end walls of the outer housing.

3. The liquid filter of claim 1 wherein at least one filter is fastened to the first end wall and at least one filter is fastened to the second end wall.

4. The liquid filter of claim 1 further comprising an inlet pipe in fluid communication with the inlet of the outer housing.

5. The liquid filter of claim 1 further comprising a solids trap at a bottom of the outer housing for collecting solids not in fluid suspension.

6. The liquid filter of claim 5 further comprising a drain in communication with the solids trap for removal of solids from the outer housing.

7. The liquid filter of claim 5 further comprising a pump to discharge the collected solids from the solids trap.

8. The liquid filter of claim 1 wherein the filter captures solid particles sized between 2-100 micrometers.

9. The liquid filter of claim 1 wherein the outlet on the outer housing is positioned on one of the end walls.

10. The liquid filter of claim 1 wherein the outlet on the outer housing is positioned adjacent to the bottom of the outer housing.

11. The liquid filter of claim 1 further comprising a filter screen positioned adjacent and exterior to the at least one filter.

12. The liquid filter of claim 1 further comprising a pump for discharging the filtered liquid from the outer housing through the at least one outlet.

13. The liquid filter of claim 1 wherein the outlet pipe of the filter drum extends at least a portion of the way into the filter drum.

14. The liquid filter of claim 1 wherein at least a portion of the side wall of the filter drum is adjacent to the outer wall of the outer housing.

15. The liquid filter of claim 1 wherein the filter drum is centrally located within the outer housing.

16. A liquid filter, comprising:
an outer housing having an outer wall and a pair of end walls positioned on opposed sides of the outer wall, the outer housing having an inlet and at least one outlet;
a filter drum having a side wall, a first end wall and a second end wall, the first end wall and the second end wall being positioned on opposed sides of the side wall, the filter drum being secured within the outer housing, the filter drum having at least one filter attached to the side wall to allow liquid to flow from an exterior of the filter drum to an interior of the filter drum, the inlet being positioned on the outer housing such that liquid is fed tangentially in relation to the filter drum through the inlet to create a centrifugal force within the outer housing causing solid particles to be forced towards the outer wall of the outer housing, the filter drum having at least one outlet pipe in fluid communication with the interior of the filter drum and the at least one outlet of the outer housing through which filtered liquid may pass.

17. The liquid filter of claim 16 wherein the inlet is positioned on the outer wall equidistant from the pair of end walls of the outer housing.

18. The liquid filter of claim 16 further comprising an inlet pipe in fluid communication with the inlet of the outer housing.

19. The liquid filter of claim 16 further comprising a solids trap at a bottom of the outer housing for collecting solids not in fluid suspension.

20. The liquid filter of claim 19 further comprising a drain in communication with the solids trap for removal of solids from the outer housing.

21. The liquid filter of claim 19 further comprising a pump to discharge the collected solids from the solids trap.

22. The liquid filter of claim 16 wherein the filter captures solid particles sized between 2-100 micrometers.

23. The liquid filter of claim 16 wherein the outlet on the outer housing is positioned on one of the end walls.

24. The liquid filter of claim 16 wherein the outlet on the outer housing is positioned adjacent to the bottom of the outer housing.

25. The liquid filter of claim 16 further comprising a filter screen positioned adjacent and exterior to the at least one filter.

26. The liquid filter of claim 16 further comprising a pump for discharging the filtered liquid from the outer housing through the at least one outlet.

27. The liquid filter of claim 16 wherein the outlet pipe of the filter drum extends at least a portion of the way into the filter drum.

28. The liquid filter of claim 16 wherein the side wall of the filter drum is adjacent to the outer wall of the outer housing.

29. The liquid filter of claim 16 wherein the filter drum is centrally located within the outer housing.
